(19) United States
(12) Patent Application Publication
(10) Pub. No.: US 2014/0365359 A1
(43) Pub. Date: Dec. 11, 2014

(54) Alternative customer tracking for parking facilities

(71) Applicant: Clyde Bartlett Wilson, Houston, TX (US)

(72) Inventor: Clyde Bartlett Wilson, Houston, TX (US)

(21) Appl. No.: 14/061,604

(22) Filed: Dec. 20, 2013

Related U.S. Application Data
(60) Provisional application No. 61/755,733, filed on Jan. 23, 2013.

(51) Int. Cl. G06Q 10/02; G06Q 20/18

(52) U.S. Cl. CPC G06Q 10/02; G06Q 20/18
USPC 705/39

(57) ABSTRACT

The customer starts a parking experience by entering an identifier, such as a phone number or thumb print, using a Flow Thru Box to record the individual and the time they entered, combined with the capture of his/her License Plate information to identity the vehicle. The vehicle identity and the customer identity are then joined (such as identifier and time). This information is stored in a server for retrieval when customers wish to calculate their time for payment. The customer arrives at a Flow Thru Box and enters their information so the Flow Thru software can find their parking record stored on the server. That information is used to calculate the time parked and the associated fee. When the customer exits the facility in their vehicle the License Plate camera records the vehicle License Plate information and checks the server to determine if the driver of the vehicle has paid.

### INTRODUCTION

The invention is the Flow Thru Parking system which uses the phone # of the customer or unique to the individual identifier to replace the parking ticket issued by the ticket dispensing machine or employee to the customer. The inventor of the Flow Thru parking system is Clyde B. Wilson Jr. a US resident of Houston, Tex.

### BACKGROUND OF THE INVENTION

1. The invention relates to the way a customer enters, pays, and exits a parking facility, with a particular focus on the replacement of the parking ticket used to track the time of the customer entry into a parking facility.

2. Generally, parking facilities charge for the amount of time a customer is parked in a facility. To know this time, over the years parking facilities have used a parking ticket that has printed on the face of the ticket the time, date, facility code, and lane number. Typically the parking ticket is made of paper and issued from a machine that encodes the ticket with the identifying information described above.

3. The information is coded on the paper ticket by printing the information on the face of the ticket and/or by placing the information on the ticket's magnetic strip or on a bar code. The parking ticket is issued to the customer usually at the entrance of the parking facility, and at the time of entry, the time of the customer's stay in the facility starts.

4. To pay for parking, the customer must present the ticket received from the entry machine at an exit station. The exit station can be a pay-on-foot (P.O.T) station a person walks up to, that accepts the ticket to compute the fee, and then accepts the customer's payment in the form of a credit card, cash, validation, etc. The exit station can also be a similar device in the exit lane, or a human cashier.

5. The parking customer must present to the machine or human cashier the ticket received at the entrance to enable them to compute the parking fee due. At the P.O.F. station or at the exit lane station, the customer must insert the ticket into the machine. The machine has a tractor feed that moves the ticket into and over the read heads to read the magnetic strip or the bar code. If the reader is dirty because of paper dust, if the software developed issues on the entry machine, if the customer has damaged the ticket so that the bar code or magnetic code cannot be read, or if the customer has come into contract with a magnetic field, the ticket information may not be readable. Also, in the era of automation, most customers will pay for their parking at a pay-on-foot station, a machine customers walk up to in order to pay, that is not located at the exit of the facility. The P.O.F. stations are also remote from the customers' cars, so the customers must remember to take their entry tickets with them after parking, when they exit their cars. If the customers do not take their ticket with them, they will not have the ticket with the entry information required to compute their fee in order to make payment.

6. After the customer pays at the P.O.F. station, the ticket has new, payment information encoded on it. The customer must then stop at the exit gate and present the ticket to the in-lane exit machine or human cashier. This process is to determine that the customer has paid for his/her parking before he/she is let out of the facility. It also confirms that since the payment at the P.O.F station, that the customer has not exceed the amount of time allowed from the time of payment to when he/she must arrive at the exit in order to not incur additional time charges (referred to as the “grace period”). If the customer does not reach the exit in the predetermined grace period amount of time (such as fifteen-minutes), the customer will have to pay an additional fee for the excess time. This whole process is very bulky, requiring many steps, and is prone to errors. The process requires the Operator of the parking operation to regularly stock the ticket issuing machines at the entrance with tickets, order, track, securely store the tickets, and make sure all the various moving parts in the ticket dispenser are not scratching the tickets as they move inside the machine. On the consumer side, the current process requires the customer to take the ticket from the machine and find temporary storage before proceeding through the entrance. It requires them to remember to take their ticket with them as they exit their vehicle, and to carry around this piece of paper with them that contains the entry time information. It is paper that can bend, tear, get wet, get lost, or get demagnetized. The Flow Thru system is designed to correct the wide variety of inefficiencies with these processes.

7. Contract Parkers are billed on a regular basis, they do not pull tickets to enter the garage or make payments each time they leave. Contract Parkers use an encoded card, badge, or Automatic Vehicle identification (A.V.I.) access device that has a specific number to differentiate the individual Contact Parker. Those cards can be left at home, malfunction, the reader can malfunction, the cards can be turned off accidentally, be left in another vehicle, or the AVI is attached only to one vehicle and the contract parker drove a different vehicle.

8. All of these issues cause access to be difficult and the Contract Parker has to get assistance to enter or exit the facility.

9. With The Flow Thru system, the Contract Parkers will register their license plates, AVI codes, or contract card code, along with their phone number or other identifying code.

10. In The Flow Thru system, if Contract Parkers want to use their AVI access devices, but they are in a different car, they can use their phone numbers or unique identifiers for access. If the Contract Parkers are using a contract card for access, and they do not have it at the entrance or exit to the facility, they can use their phone number or unique identifier.

11. The Flow Thru system uses devices to recognize the characters on each vehicle's license plate upon entering a parking facility. If they drive more than one vehicle, Contract Parkers in The Flow Thru system will have the ability to register multiple license plate numbers for access to a Flow Thru facility. If the devices reading license plates cannot identify the characters, the Contract Parker can simply use his/her phone number or unique identifier to enter and exit the facility.

### SUMMARY OF THE INVENTION

12. In order to address the inefficiencies and line of errors with the parking ticket and current processes in entering, paying, and exiting a parking facility, The Flow Thru invention removes the need for Contract Parkers to use access devices and the requirement for regular parking customers to carry around with them any type of document issued to them over the Internet or at the entrance (such as a ticket). However, parking customers may have the option to use issued documents, such as validations or Internet coupons.

13. For non-Contract Parkers, the invention is for the customer to drive in the entrance of a parking location to a kiosk, pedestal, or other such set-up where an entry device could be installed. Into the stationed Flow entry device the parker will type or speak a predetermined number of characters (numbers and or letters), such as 7-10 characters, that he/she will later use as an identifier when paying. Or he/she can use an identifier (primarily personal and unique) that will later be replicated at the pay machine in order to calculate the time in the facility and required payment. These identifiers include, but are not limited to:
Numbers, such as phone numbers, birthday, or a combination of personal numbers.
Words or strings of number or letters.
Touch
Voice
Eye scans
Other personal biometrics 14. Devices read and record each license plate entering the parking area. Those license plates are then recorded and matched to the characters or unique identifier used at the entry (such as a phone number or voice recognition). The event time (in this case the entry time) is then attributed to those two elements (license plate and personal identifier.)

15. Non-Contract Parker customers can now enter the facility without a ticket and without the need to carry a ticket with them after parking.

16. For customers to pay for their parking, they will simply need to replicate the information or identifier used at the entrance. An example of this would be typing or speaking the same number used to enter or using the same biometric touch signature pattern. The system then knows what time a parker entered the facility and can calculate the required payment. The customer can pay using a variety of options including, but not limited to cash, (at stations that have cash capability) credit cards, validations, Internet discount certificates, using a cell phone, or using a reservation.

17. The phone number or other identifier was matched with the license plate of the vehicle at the entrance, so after payment, the system knows that a payment for a specific license plate has been made.

18. Near the exit, the vehicle will drive by a device that will capture the license plate and query the system to learn the payment status of this plate. If the parker has paid, the system will open or keep open the exit gate. If the parker has not paid, he/she will be not be allowed to exit until payment is made at the exit station.

19. For Contract Parkers, the phone number or identifier can be used in lieu of, or as an ancillary control to, access devices such as badges, cards, or A.V.I. The system can be programmed where the entry gate will open or remain open if the vehicle entering has a license plate registered to a Contract Parker.

20. If Contract Parkers drive multiple vehicles, the Flow Thru system will allow them to register each of their vehicles' license plate numbers so each one of their vehicles can gain access to a Flow Thru parking area. If the on-site devices has an issue reading the license plate of a contract parker, a customer can simply use their phone number or unique identifier to gain access to the parking facility.

### DESCRIPTION OF THE FIGS.

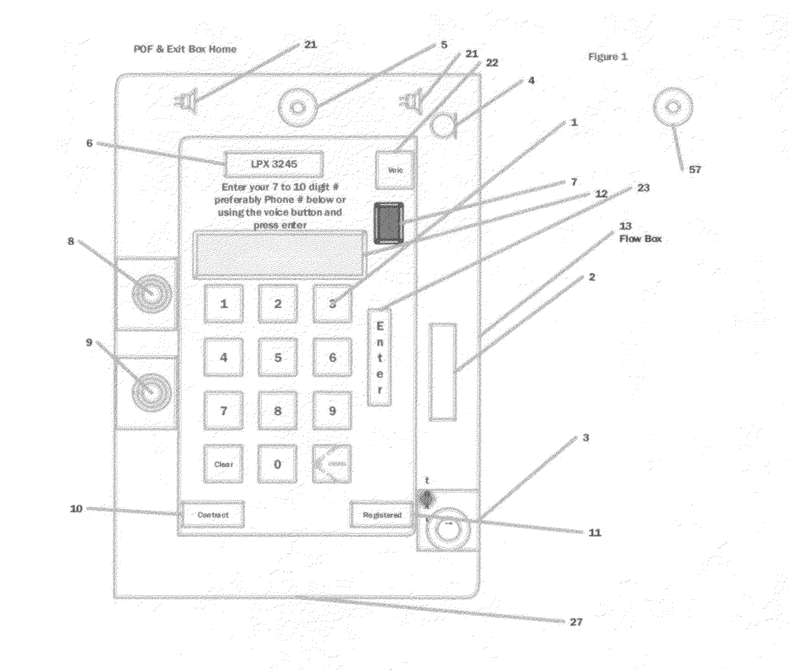

21. FIG. 1 is the Flow Thru Kiosk with all of its embodiments for entry, POF, and in-lane exit.

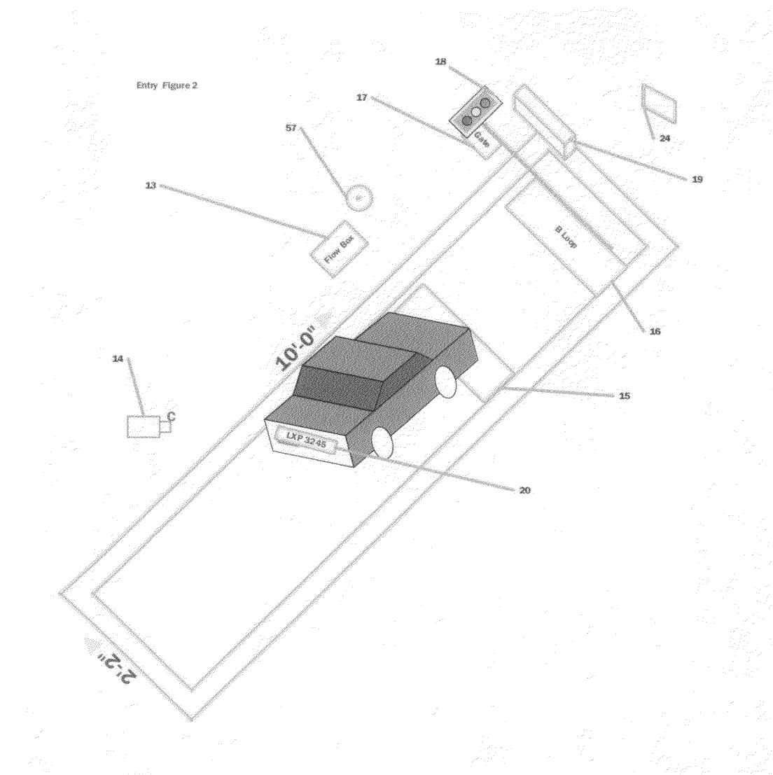

FIG. 2 represents the typical lane configuration of a typical facility entrance with all of the embodiments of a typical parking entrance lane.

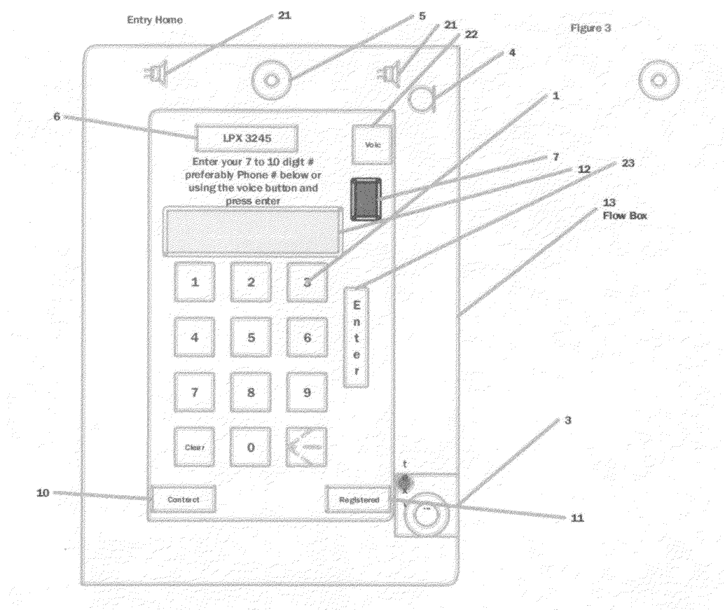

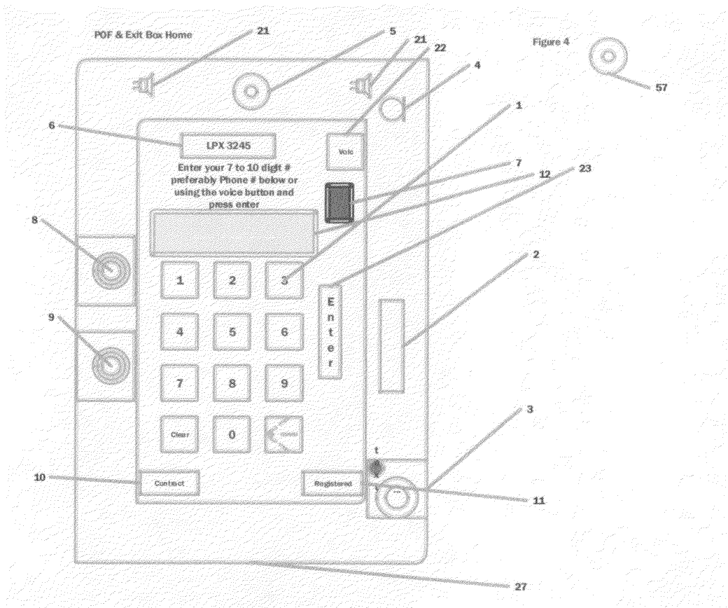

FIG. 3 is the Flow Thru box used only at the entrance and without the payment methods included in FIGS. 4,8, and 9.

FIG. 4 is the typical pay-on-foot station

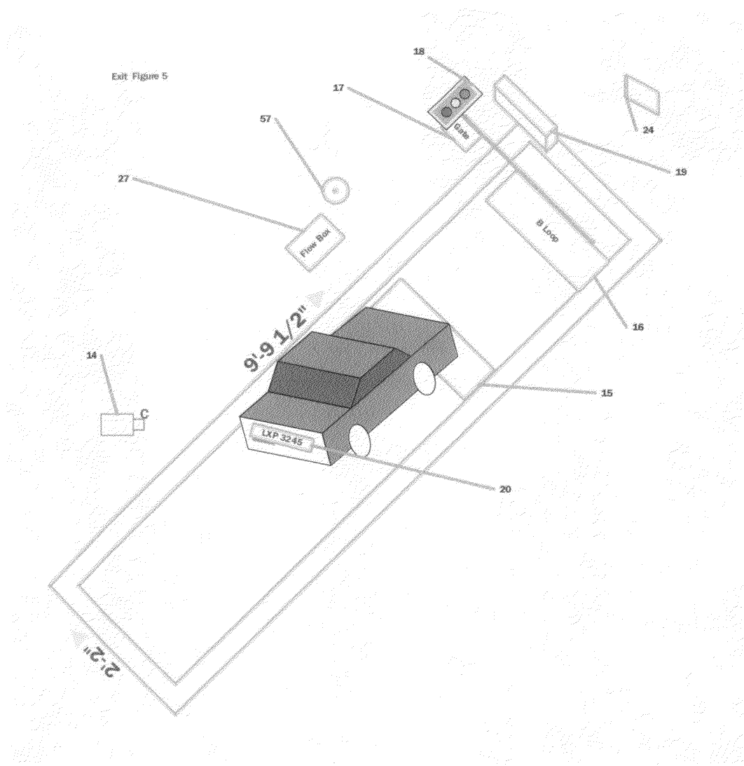

FIG. 5 is the typical exit lane

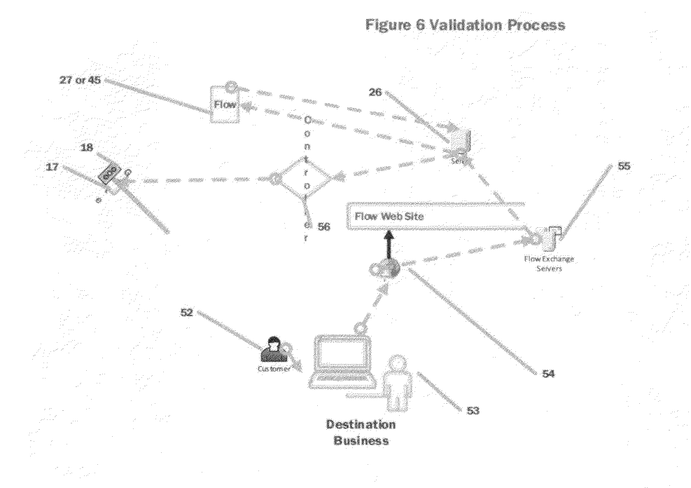

FIG. 6 is the Validation process

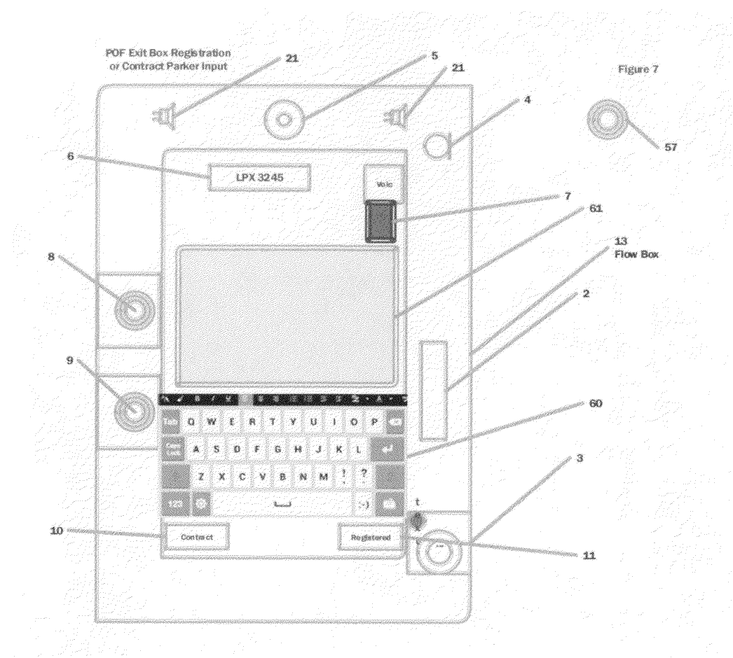

FIG. 7 shows the registration screen

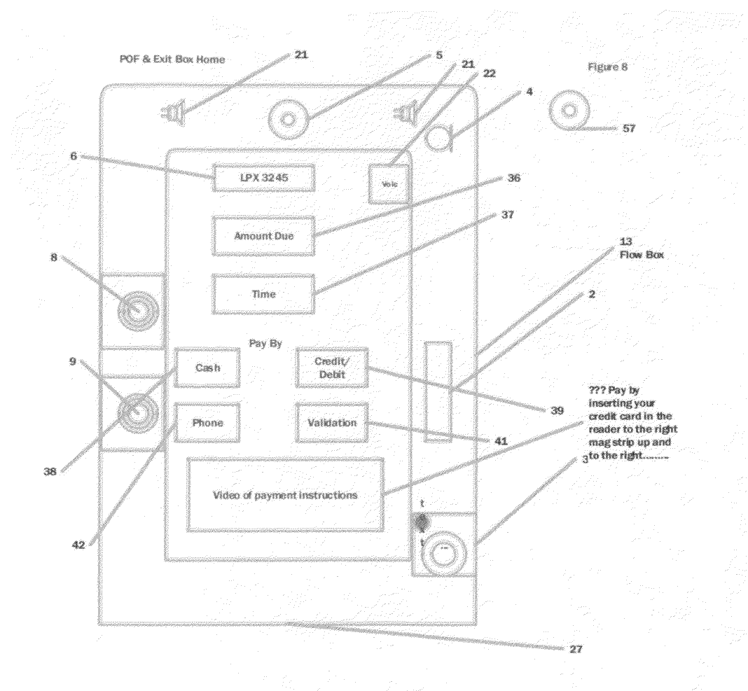

FIG. 8 shows the payment screen

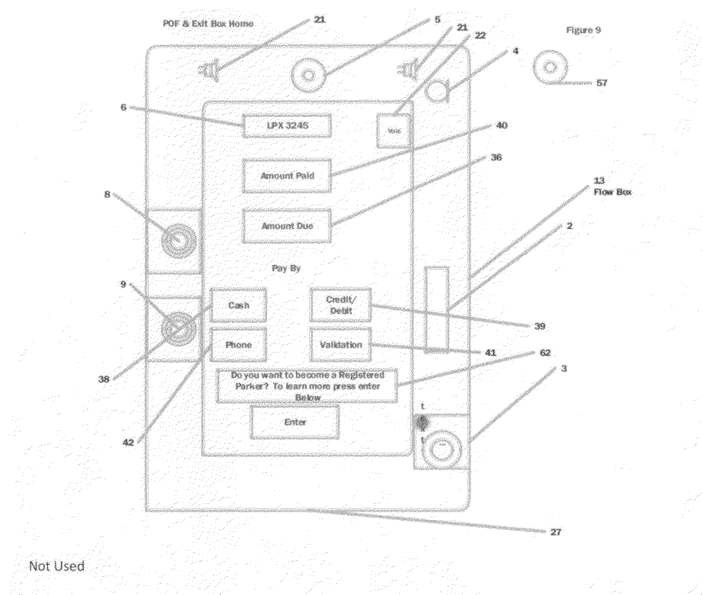

FIG. 9 shows the second payment screen

### DESCRIPTION OF THE PREFERRED EMBODIMENTS

22. For the purposes of promoting an understanding of the principles of the invention, reference will now be made to the embodiments illustrated in the drawings and specific language will be used to describe the same. It will nevertheless be understood that no limitation of the scope of the invention is hereby intended. The invention includes any alterations and further modifications in the illustrated devices and described methods and further applications of the principles of the invention which would normally occur to one skilled in the art to which the invention relates.

23. The present invention contemplates using the customers phone # or any other unique to the individual identifier, ie. But not limited to Birth date, social security #, driver's license #, address, thumb or finger print, palm print, voice print to be provided to a Flow Thru device at the entrance to a parking facility or at the location a customer would provide their entry time for the purpose of being the customer identifier during their stay in the facility. The following description of the preferred embodiment envisions use of the invention as part of a parking facility. However, it should be understood that other applications of the inventive concepts disclosed herein are contemplated beyond the illustrated embodiment.

24. In accordance with a preferred embodiment of the invention, an entry for a parking facility will replace the traditional ticket dispensing machine with a Flow Box 13 in FIG. 1 and a License Place Recognition camera 14. The traditional gate mechanism 17 In FIG. 2 used to block access until a parker proves with a credential they are a contract parker or they have a ticket to compute their payment may or may not be replaced with a sign 18 & 19 that will give the go or stop message to the customer. The Flow Box 13 will go live and the camera 14 will take a picture of the License Plate 20 of the entering vehicle when a vehicle passes over the magnetic detection loop 15.

25. When a customer in a vehicle arrives at an entering Flow Box 13 the Flow Box screen will display 6 the License Plate of the vehicle, will verbally announce through speakers 21 or other speakers in a video machine located adjacent to the Flow Box the message to enter or speak you 7 to 10 digit number preferably your phone # using the key pad 1 or the voice button 22 and microphone 4 and hit the enter button 23. As the customer enters the number using the key pad 1 or the voice button 22 the number entered will display on the screen 12. When the customer hits the entry button 23 the number entered by the customer becomes the identifier the customer will need to calculate their parking fee at the POF 27 or exit station 28. That number is then stored in the location server 26 to be recalled when the customer is ready to pay at a POF station 27 or exit Flow Box 28. Additionally, for the purpose of speeding the exit the License Plate number 20 will be stored and paired to the number entered in screen 22.

26. The customer no longer needs to carry a paper ticket because they have the number they entered at the entry Flow Box 13. At a POF station 27 the parking software stored on the server 26 needs to identify the customer so it can check to see the date, time, location, of the entry in order to compute the amount due. To accomplish this preferred embodiment of a Flow Thru System the customer enters the phone number or unique to the individual identifier they presented to the entry Flow Box 13 by using the key pad 1 or the voice button 22 and microphone 4 to identify the time they entered the facility. The next screen in the POF station will be FIG. 8 showing the amount due 36 and the total time parked 37 and the payment options 38,39,42. The customer pays by their preferred method and the screen in FIG. 9 is presented. In this screen the first window shows the amount paid 40 and if there is still a balance the next screen 41 shows the amount due.

27. The preferred embodiment of the Flow Thru System links the payment using the phone number or unique to the individual identifier to the customers License plate 20, or AVI 24. When the customer arrives at the exit to the parking facility the License Plate camera in the exit lane 43 takes a picture of the customers license plate and matches it to the customers phone # or unique to the individual identifier. The Flow Thru software in the server knows that the phone # or unique to the individual identifier linked to the license plate 20 has paid so there is no need for the customer to stop before they exit the parking facility. In most parking facilities there is a time limit to the amount of time lapsed from the payment at the POF to the exit and this limit is called the exit grace period. When the vehicle arrives at the exit the exit lane License Plate camera 43 takes the picture and sends the information to the server 26 with a result of a grace period violation. The preferred embodiment uses the phone # or unique to the individual identifier linked to the license plate or AVI. The information from the server will identify the exiting vehicles license plate 44 as a plate linked to a phone # or unique to the individual identifier that has paid but crossed the exit grace period therefore owes an additional amount.

28. In this case the customer will act as a customer that did not stop at a POF to pay and simply arrived at the exit lane. The exit LP camera 43 takes the picture of the LP 44 and sends it to the server 26. The server determines if this LP belongs to a customer that entered the facility using their phone # or unique to the individual identifier but has not paid or has passed the exit grace period. The exit gate will stay down, and/or the exit light will stay red and the vehicle will stop at the exit Flow Box 45. The customer will enter their phone # or unique to the individual identifier using the key pad 1 or the voice button 22 and microphone 4 into the exit Flow Box. The phone # LP match will be checked at the Server and the Flow box screen will show the amount due 36 and the time parked 37 and the payment options 38,39,42. Once the customer selects a payment option the screen on the Flow Box 45 changes to the screen in FIG. 5 showing the Amount Paid 40, Balance Due 41 and payment options 38,39, and 42 if there is a remaining balance. Once the total due is paid the gate goes up and or the traffic light 47 goes green, the Flow Box screen changes to green, and the customer exits the garage.

29. If at any time during the entry, POF, or exit transaction the customer may activate the intercom 3 and talk at an assistant who can help with the completion of the transaction.

### VALIDATION

30. A validation is a type of transaction where the destination (validator) of a parking customer wishes to pay part or all of the customers parking fee. Traditionally the customer must have their paper parking ticket with them to be used by the validator to process the validation. In the case of the preferred embodiment the customer has used their phone # or unique to the individual identifier to identify what facility they parked in and the time of their entry. When the destination 53 FIG. 6 of the parking customer 52 is ready to validate the customer 52 gives the destination employee 53 their phone # or unique to the individual identifier and the employee 53 enters it into the Flow Thru web page 54 along with the amount in terms of time or currency of the validation. The web communicates with the Flow Thru central server 55 which in turn communicates with the location server 26. When the customer arrives at either the Flow Box POF 27 or exit Flow Box 45 and enters their phone # or unique to the individual identifier The Flow Box 27 or 45 communicates with the server 26 and finds a validation amount tagged to this phone # or unique to the individual identifier. The server uses the amount of the validation to calculate the parking charge and communicates with the Flow Box 27 or 45. Once the fee has been satisfied the server communicates with the lane controller 56 to open the gate 17 and/or turn the exit light 18 green.

### REGISTERED PARKER

31. One of the key features of the preferred embodiment is that the visiting customer carries with them always the tools to be recognized in any parking facility that is a Flow Thru facility, their phone # or unique to the individual identifier. Upon entry to a facility for the first time the phone # or unique to the individual identifier is matched to the LP # of the customers vehicle. IF the customer chooses to be registered in the Flow Thru Software and add a credit card to their account they can enter and exit either by using their LP # or their phone # or unique to the individual identifier without having to stop for payment.

### CONTRACT PARKER

32. Contract parkers can enter the facility using either their contract access card, AVI card, or they can have their License Plate number of each of their vehicles registered. Any one of these three access methods can be used for access and exit of a parking facility. The preferred embodiment a phone # or unique to the individual identifier will be a back-up when or if the chosen contract parker access method fails. The contract parker who's preferred method of contract access fails for any reason can simply go to the Flow Box and enter the phone # or unique to the individual identifier that is on file with the Flow Thru system and gain access to the facility. The customer will need to contact Flow Thru management to correct the error with their preferred method of access before they will be allowed to exit the garage.

### ALTERNATIVE CUSTOMER TRACKING FOR PARKING

1. Entry key pad

2. Credit card reader

3. Intercom

4. Microphone for voice entry

5. Camera

6. Area on screen for LP #

7. Thumb Print

8. Bar Code Scanner

9. Contactless credit card reader

10. Contract Button

11. Registered Parker Button

12. Location of number used to register vehicle

13. Flow Box

14. LPR Camera

15. Magnetic Detection Entry Loop

16. Magnetic Detection Entry Loop

17. Exit Gate

18. Red Green traffic Light

19. Lighted sign

20. Vehicle License Plate

21. Speakers to announce instructions to customers

22. Button to activate voice entry

23. Enter button used to end the session

24. Automatic Vehicle Identification (AVI)

25. Not Used

26. Location server

27. Flow Box

28. Exit pay station

29. Not Used

30. Not Used

31. Not Used

32. Not Used

33. Not Used

34. Not Used

35. Not Used

36. Amount Due

37. Total time parked

38. Payment Options

39. Payment Options

40. Amount paid

41. Payment Options

42. Payment Options

43. Exit LP Camera

44. Exiting vehicles LP #

45. Flow Box

46. Exit traffic Light

47. Not Used

48. Not Used

49. Not Used

50. Not Used

51. Not Used

52. Validation Parking customer

53. Validation Client

54. Flow Thru Web Page

55. Flow Thru Central server

56. Lane Controller

57. Command Center Camera

58. Not Used

59. Not Used

60. Touch screen key board

61. Screen for entry from touch screen key board

62. Registered Parker Notice

1. As laid out in detail in the above sections, the claim is for the use of a phone number, or other identifier, such as a fingerprint, that a person can use for entering a parking location, paying for parking, and/or exiting a parking location. We would like the patent the use of voice, typing, or other similar methods for establishing when a vehicle or parker interacts with parking equipment used during a parking experience. The patent is intended to prevent replication of the concept or technology. To illustrate the concept here are three brief examples, however, these do not fully encompass the scope of the requested patent which is outlined in more detail in the sections above. The inventor wants to claim using these and similar methods, in a parking scope, to track or assist with entrance, and/or payment, and/or exiting:
1. A person types his or her phone number, string of numbers, words, strings of letters, and or strings of letters and numbers with equipment used during the scope of a parking experience for the purpose of establishing an entry and/or exit time used to calculate a parking time and applicable parking charge or the presence of a customer.
2. A person using his or her fingerprint or eye scan(s) with equipment used during the scope of a parking experience for the purpose of establishing an entry and/or exit time used to calculate a parking time and applicable parking charge or the presence of a customer. A person speaks his or her phone number, string of numbers, words, strings of letters, and or strings of letters and numbers into equipment used during the scope of a parking experience for the purpose of establishing an entry and/or exit time used to calculate a parking time and applicable parking charge or the presence of a customer.
These are three limited examples that are listed to provide a general understanding of the types of ideas and concepts intended for use under the patent, but should not limit restriction. The invention includes any alterations and further modifications of the principles of the invention which would normally occur to one skilled in the art to which the invention relates.
